(19) United States
(12) Patent Application Publication
(10) Pub. No.: US 2025/0138250 A1
(43) Pub. Date: May 1, 2025

(54) EXTENDER PORTS HAVING ROTATABLE END CAPS AND OPTICAL ASSEMBLIES INCORPORATING THE SAME

(71) Applicant: CORNING RESEARCH & DEVELOPMENT CORPORATION, Corning, NY (US)

(72) Inventors: Micah Colen Isenhour, Lincolnton, NC (US); Zachary Michael Thompson, Austin, TX (US)

(21) Appl. No.: 18/385,763

(22) Filed: Oct. 31, 2023

(51) Int. Cl. G02B 6/38

(52) U.S. Cl. CPC G02B 6/3825; G02B 6/3879; G02B 6/3891; G02B 6/3897

(57) ABSTRACT

An extender port for optically coupling a first fiber optic connector and a second fiber optic connector includes a housing having a first end, a second end, a first passageway, and a second passageway. The extender port also includes a first lock assembly and a second lock assembly that each include a shuttle disposed on an inner surface of the housing within one of the first passageway and the second passageway. The shuttle includes a slot, a latch includes a pivot end and a latching end. The latch is coupled to the shuttle such that the pivot end is disposed within the slot of the shuttle. The first and second lock assemblies include an end cap rotationally disposed within one of the first passageway and the second passageway and includes a body, an end cap passageway within the body, a release arm, and a lock arm.

### FIELD

The present disclosure is directed to extender ports and, more particularly, extender ports having a rotational lock and unlock configuration.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure.

Optical connectors are utilized to make optical connections from an optical fiber trunk to individual network subscribers. Closures such as fiber optic terminals have ports that receive fiber optic connectors of fiber optic drop cables that are run from the terminal to the individual subscribers. The ports and the fiber optic connectors are hardened and designed to withstand the outdoor conditions as they are typically deployed in a buried or aerial environment. The hardened ports and fiber optic connectors prevent moisture, dust and debris from affecting the optical connector between optical fibers of the ports and the fiber optic connectors.

It may be difficult and costly to provide optical fiber drop cables to rural subscribers in a FTTP network. Traditional systems are ideal when used in urban areas due to the density of homes (i.e., subscribers) passed, and the relatively short drop cables attached to the main optical cable trunk. However, addressing rural applications is more challenging for present systems. It is difficult to create the longer cable drops needed in a rural environment due to the way these optical cables are manufactured and reeled for deployment. In rural settings it is not uncommon to encounter single family dwellings spread by more than 1000 meters. Not only are the homes more spread out, but they may be a large distance away from the main cable path, requiring lengthy optical cable drops.

Accordingly, a need exists for alternative devices, systems and methods of providing flexibility such that optical cable drops may be provided to rural subscribers in an economical manner.

### SUMMARY

The present disclosure is directed to extender ports that enable mating between a fiber optic connector with a port for which the fiber optic connector was not designed. The extender ports described herein include a housing and an end cap that is rotationally coupled to the housing. The end cap includes locking and unlocking features that actuate a latch within the housing to lock and unlock an inserted fiber optic connector from the extender port. The extender ports described herein are simple and use fewer parts than existing designs, while also providing strong tensile force resistance.

In one embodiment, an extender port for optically coupling a first fiber optic connector and a second fiber optic connector includes a housing having a first end, a second end, a first passageway for receiving the first fiber optic connector, and a second passageway for receiving the second fiber optic connector. The extender port also includes a first lock assembly and a second lock assembly, where each of the first lock assembly and the second lock assembly includes a shuttle disposed on an inner surface of the housing within one of the first passageway and the second passageway. The shuttle includes a slot, a latch includes a pivot end and a latching end, where the latch is coupled to the shuttle such that the pivot end is disposed within the slot of the shuttle. The first lock assembly and the second lock assembly further include an end cap rotationally disposed within one of the first passageway and the second passageway. The end cap includes a body, an end cap passageway within the body, a release arm, and a lock arm, where the release arm and the lock arm extend from the body such that the release arm pivots the latch to a released position when the end cap is rotated in a first direction with respect to the housing. The lock arm pivots the latch to a locked position when the end cap is rotated in a second direction with respect to the housing.

In another embodiment, an optical assembly includes a first fiber optic cable assembly comprising a first optical fiber and a first fiber optic connector, wherein the first optical fiber is disposed within the first fiber optic connector, a second fiber optic cable assembly comprising a second optical fiber and a second fiber optic connector, wherein the second optical fiber is disposed within the second fiber optic connector, and an extender port. The extender port includes a housing having a first end, a second end, a first passageway for receiving the first fiber optic connector, and a second passageway for receiving the second fiber optic connector. The extender port further includes a first end cap assembly and a second end cap assembly. Each of the first end cap assembly and the second end cap assembly includes a shuttle disposed on an inner surface of the housing within one of the first passageway and the second passageway, the shuttle having a slot. The first end cap assembly and the second end cap assembly further includes a latch having a pivot end and a latching end, wherein the latch is coupled to the shuttle such that the pivot end is disposed within the slot of the shuttle, and an end cap rotationally disposed within one of the first passageway and the second passageway, the end cap including a body, an end cap passageway within the body, a release arm, and a lock arm. Each of the first fiber optic connector and the second fiber optic connector have a connector housing with a locking face. The release arm and the lock arm extend from the body, and the lock arm pivots the latch to a locked position such that the latching end of the latch is disposed between the locking face of the connector housing to lock one of the first fiber optic connector and the second fiber optic connector to the housing when the end cap is rotated in a first direction with respect to the housing. The release arm pivots the latch to a released position such that the latching end of the latch is removed from the locking face of the connector housing to release one of the first fiber optic connector and the second fiber optic connector from the housing when the end cap is rotated in a second direction with respect to the housing.

In another embodiment, an extender port for optically coupling a first fiber optic connector and a second fiber optic connector includes a housing and a sleeve holder insert. The housing includes a first end and a second end, a first passageway for receiving the first fiber optic connector, a second passageway for receiving the second fiber optic connector, wherein an interior surface of the second passageway of the housing comprises a groove, a dividing wall separating the first passageway and the second passageway, an integrated sleeve holder that protrudes from a first surface of the dividing wall in a direction toward the first end, and a first hard stop and a second hard stop positioned at a second surface of the dividing wall. The sleeve holder insert is disposed within the second passageway and adjacent to the dividing wall, and includes a main body, a first flexible extension and a second flexible extension, and a plurality of alignment tabs. The first flexible extension and the second flexible extension protrude from a first end of the main body, bend toward a second end of the main body, and are disposed within the groove to secure the sleeve holder insert within the housing. The plurality of alignment tabs protrude from the first end of the main body, and define a first notch and a second notch. The first hard stop is positioned within the first notch, and the second hard stop is positioned within the second notch.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 illustrates an exploded perspective view of an example extender port according to one or more embodiments described and illustrated herein.

FIG. 2 illustrates a perspective view of an example optical assembly including example fiber optic connectors and the example extender port of FIG. 1 according to one or more embodiments described and illustrated herein.

FIG. 3 illustrates a top view of the example optical assembly of FIG. 2 according to one or more embodiments described and illustrated herein.

FIG. 4 is a perspective cutaway view of the example extender port of FIG. 1 according to one or more embodiments described and illustrated herein.

FIG. 5 is a perspective view of an example sleeve holder insert of an extender port according to one or more embodiments described and illustrated herein.

FIG. 6A is a cutaway view of passageways of a housing of an extender port according to one or more embodiments described and illustrated herein.

FIG. 6B is another cutaway view of a sleeve holder insert installed in the housing of FIG. 6A according to one or more embodiments described and illustrated herein.

FIG. 7 is a perspective view of a shuttle, a latch, and end cap, and a fiber optic connector inserted into the end cap in a locked state according to one or more embodiments described and illustrated herein.

FIG. 8 is a top perspective view of an example end cap of a fiber optic adapter according to one or more embodiments described and illustrated herein.

FIG. 9 is a side view of the example end cap of FIG. 8 according to one or more embodiments described and illustrated herein.

FIG. 10 is another perspective view of the example end cap of FIG. 8 according to one or more embodiments described and illustrated herein.

FIG. 11 is a front view of the example end cap of FIG. 8 according to one or more embodiments described and illustrated herein.

FIG. 12 is a close-up perspective view of the shuttle, latch and end cap in the locked state of FIG. 7 according to one or more embodiments described and illustrated herein.

FIG. 13 is a close-up side view of the shuttle, latch and end cap in the locked state of FIG. 7 according to one or more embodiments described and illustrated herein.

FIG. 14 is a cross-sectional view of the optical assembly of FIG. 2 according to one or more embodiments described and illustrated herein.

FIG. 15 is a close-up perspective view of the shuttle, latch and end cap in an unlocked state according to one or more embodiments described and illustrated herein.

FIG. 16 is a close-up side view of the shuttle, latch and end cap in the unlocked state of FIG. 15 according to one or more embodiments described and illustrated herein.

FIG. 17 is an exploded perspective view of another example extender port according to one or more embodiments described and illustrated herein.

FIG. 18 is a front perspective view of an example sleeve holder insert of the example extender port of FIG. 17 according to one or more embodiments described and illustrated herein.

FIG. 19 is a top perspective view of the example sleeve holder insert of FIG. 18 according to one or more embodiments described and illustrated herein.

FIG. 20 is a cutaway view of the example sleeve holder insert of FIG. 18 installed in a housing according to one or more embodiments described and illustrated herein.

FIG. 21 is another cutaway view of the example sleeve holder insert of FIG. 18 installed in a housing according to one or more embodiments described and illustrated herein.

FIG. 22 is a cutaway view of the example sleeve holder insert of FIG. 18 installed in a housing with two fiber optic connectors inserted into the housing according to one or more embodiments described and illustrated herein.

### DETAILED DESCRIPTION

Reference will now be made in detail to the embodiments of the disclosure, examples of which are illustrated in the accompanying drawings. Whenever possible, like reference numbers will be used to refer to like components or parts.

Embodiments of the present disclosure are directed to extender ports for extending optical cable drops into longer lengths, which may be advantageous in deploying a FTTP network in rural settings, or other settings where subscribers are separated by large distances. The extender ports described herein are outdoor/indoor standalone adapters operable to mate two hardened optical connectors, such as PushLok™ optical connectors sold by Corning Optical Communications of Charlotte, NC. If an optical cable drop does not have a sufficient length, an extender port of the present disclosure may be utilized to connect two optical cable drops together to achieve the length needed to reach a subscriber.

The extender ports described herein include a housing and two end caps that are rotationally coupled to the housing. Each end cap includes locking and unlocking features that actuate a latch within the housing to lock and unlock an inserted fiber optic connector from the extender port. The extender port is simple and uses fewer parts than existing designs, while also providing strong tensile force resistance.

More particularly, the rotating end caps eliminate the need for external unlocking features, such as a push-button, and therefore eliminates a potential leak path and failure mode and thus reduces performance risk. Further, the designs of the extender ports described herein decouple the retention force from the user actuation force, so adjusting the retention force does not affect the user experience in any way. For example, increasing the retention force does not require a larger or different user input to release or lock the connector. The user experiences the same actuation force when turning the end cap and then pulling the fiber optic connector out of the extender port.

Various embodiments of extender ports, and fiber optic connector assemblies are described in detail below.

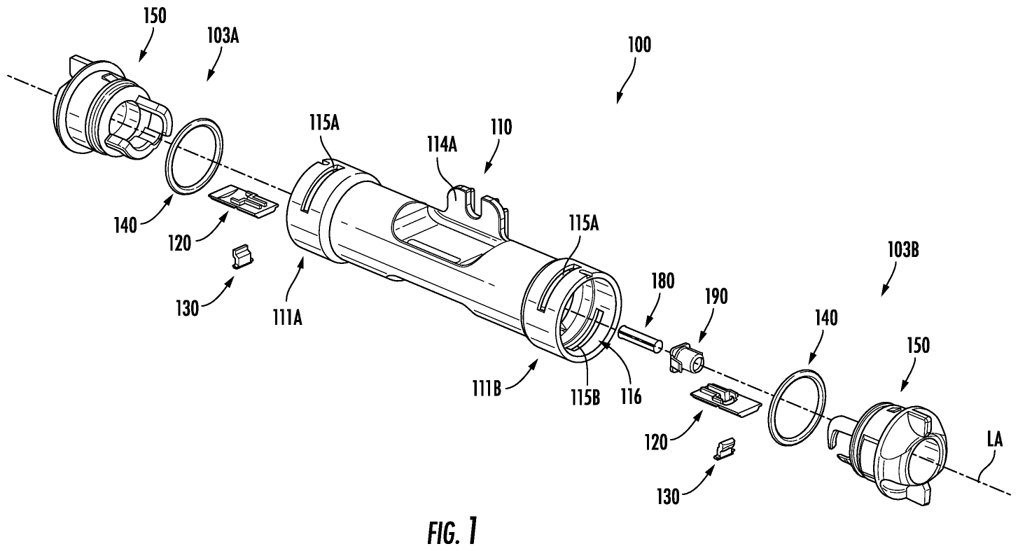

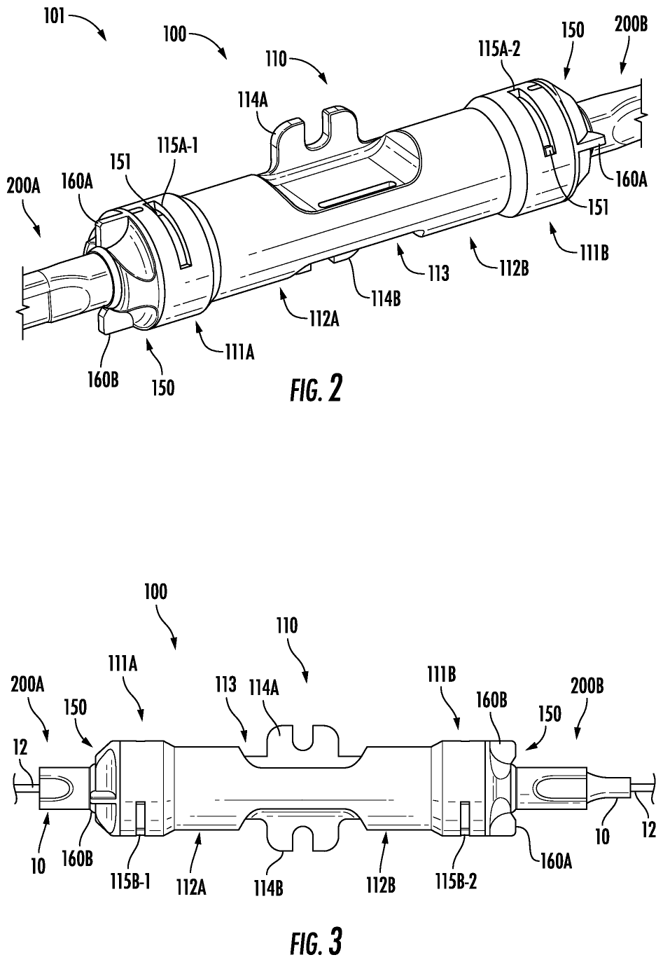

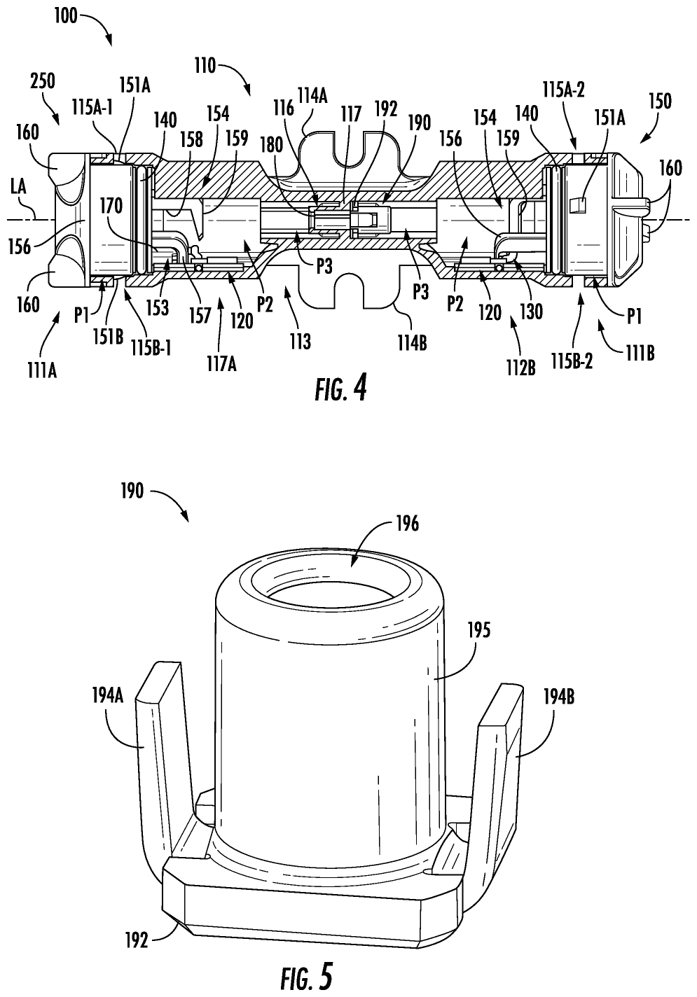

Referring now to the drawings, FIG. 1 illustrates an example extender port 100 in an exploded view. FIG. 2 illustrates an assembled perspective view of an example fiber optic connector assembly 101 including both the extender port 100 of FIG. 1 as well as a first fiber optic connector 200A and a second fiber optic connector 200B that are inserted into the extender port 100. FIG. 3 illustrates a side view of the extender port 100 of FIG. 1.

Referring generally to FIGS. 1-3, the example extender port 100 generally includes a housing 110, a ferrule sleeve 180, a sleeve holder insert 190, a first lock assembly 103A, and a second lock assembly 103B. Each lock assembly 103A, 103B includes a shuttle 120, a latch 130 pivotally coupled to the shuttle 120, an end cap 150, and a sealing element 140. The end cap 150 and the housing 110 define a longitudinal axis LA of the extender port 100.

The housing 110 has a generally cylindrical shape to and defines a passageway 118 for accepting the end caps 150 and fiber optic connectors 200A, 200B (collectively “fiber optic connectors 200”). The housing 110 has a first end 111A for receiving the first fiber optic connector 200A and the first lock assembly 103A, and a second end 111B for receiving the second fiber optic connector 200B and the second lock assembly 103B. The first and second ends 111A, 111B of the housing 110 have a diameter that is configured to receive and maintain the end caps 150 of the first and second lock assemblies 103A, 103B, respectively. The diameter of the housing decreases from the first and second ends 111A, 111B to smaller diameter first and second connector portions 112A, 112B. The diameter of the first and second connector portions 112A, 112B is such that the connector housings of the first and second fiber optic connectors 200A, 200B are securely maintained within the housing 110. The housing further includes a notched area 113 at a central location. As described in more detail below, the ferrules of the fiber optic connectors 200 are maintained within the notched area 113 of the housing 110.

The housing 110 may also include tabs 114A, 114B for mounting the housing 110 to a surface with fasteners, such as screw or bolts. The housing 110 may also include a slot operable to receive a band for strap attachment to a component, if desired.

The first end 111A and the second end 111B of the housing 110 each include a first slot 115A and a second slot 115B that receive a first latch protrusion 151A and a second latch protrusion 151B of the end caps 150, respectively. In other embodiments, only one slot and one protrusion are provided, or more than two slots and two protrusions are provided. As described in more detail below, the first and second slots 115A, 115B and first and second latch protrusions 151A, 151B prevent longitudinal movement of the end caps 150 with respect to the housing 110 along the longitudinal axis LA but allow for some rotational movement with respect to the housing 110 to lock and unlock a fiber optic connector 200A, 200B from the extender port 100. The amount of rotational movement of the end cap 150 for locking and unlocking a fiber optic connector 200A, 200B from the extender port 100 is limited by the length of the first and second slots 115A, 115B. Rotational movement of the end cap 150 is prevented when the first and second latch protrusions 151A, 151B reach an end of their respective first and second slots 115A, 115B.

FIG. 4 illustrates a cross-sectional view of the example extender port 100 of FIGS. 1-3. The passageway 118 of the housing 110 includes several passageways P1-P3 to accept various components. The first passageway P1 has a diameter to accept and maintain an end cap 150. The second passageway P2 has a diameter to accept and maintain a generally cylindrical portion of an outer surface 218 of a connector housing 210 of an individual fiber optic connector 200 (see FIG. 7). The third passageway P3 is generally rectangular in shape to accept and maintain a rectangular front portion 211 of a connector housing 210 of an individual fiber optic connector 200 (see FIG. 7).

The housing 110 also includes an integrated sleeve holder 116 positioned within one of the two third passageways P3. The integrated sleeve holder 116 is molded or otherwise fabricated to be an integral component of the housing 110. The sleeve holder insert 190 is disposed within a third passageway P3 at an end opposite from the integrated sleeve holder 116 such that the sleeve holder insert 190 is adjacent to the integrated sleeve holder 116. Both the integrated sleeve holder 116 and the sleeve holder insert 190 provide a passageway for receiving a ferrule sleeve 180 that receives the ferrules 202 of the first and second fiber optic connectors 200A, 200B, as described in more detail below.

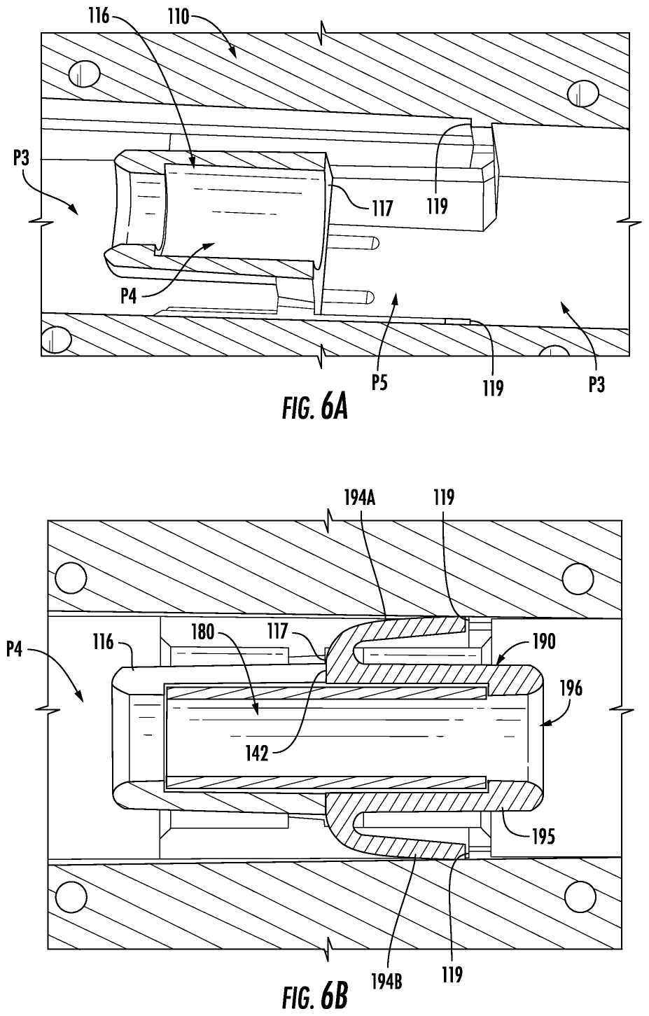

The sleeve holder insert 190 is configured to be inserted into the passageway P4 and snap into place. FIG. 5 illustrates an example sleeve holder insert 190 according to one embodiment. The sleeve holder insert 190 includes a base 192 that is operable to abut a wall 117 of the integrated sleeve holder 116. A cylindrical main body 195 extends from a center of base 192, and has an opening 196 for receiving a ferrule of a fiber optic connector 200. A first flexible extension 194A and a second flexible extension 194B extend from a perimeter of the base 142. The first and second flexible extensions 194A, 194B are arms that can flex inwardly toward the main body 195, and are features that snap back and lock the sleeve holder insert 190 into the housing 110. It should be understood that more or fewer flexible extensions may be provided. In some embodiments the first and second flexible extensions are provided in a separate component fit over the cylindrical main body 195, such as an overmolded component, for example.

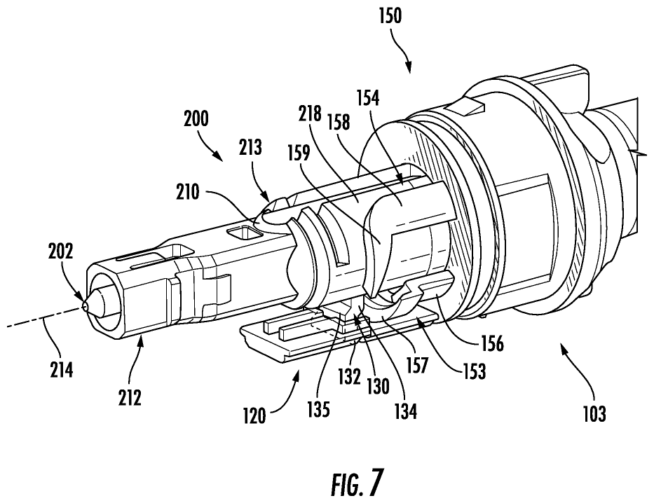

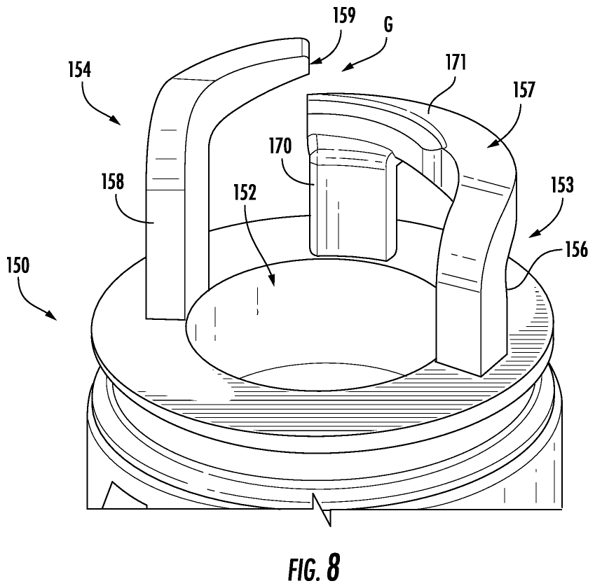

FIG. 6A is a close-up, cutaway view of the integrated sleeve holder 116 and the region of the housing 110 that receives the sleeve holder insert 190. The integrated sleeve holder 116 has a passageway P4 for receiving the ferrule sleeve 180. A passageway P5 receives the sleeve holder insert 190. An annular protrusion 119 (or multiple individual protrusions) is provided on an interior surface of the housing 110. The annular protrusion 119 acts as catch for the first and second extensions 194A, 194B. When the sleeve holder insert 190 is inserted into passageway P5, the annular protrusion 119 flexes the first and second extensions 194A, 194B inwardly toward the main body 195. After the first and second extensions 194A, 194B clear the annular protrusion 119, they snap outward to a position as shown in FIG. 6B. The annular protrusion 119 and the position of the first and second extensions 194A, 194B prevent backward movement of the sleeve holder insert 190 back out of passageway P5. It is noted that the ferrule sleeve 180 is inserted into the integrated sleeve holder 116 or the sleeve holder insert 190 prior to insertion of the sleeve holder insert 190 into the housing 110.

FIG. 7 illustrates a perspective view of a fiber optic connector 200 and a extender port 100 in a locked state with the housing 110 not visible. The fiber optic connector 200 generally includes a connector housing 210, including a ferrule retaining portion 212 at a front portion 211 of the connector housing 210. The connector housing 210 further includes a rear portion 213 positioned opposite the front portion 211 in an axial direction. The ferrule retaining portion 212 of the connector housing 210 is generally configured to hold and retain a ferrule 202 that is positioned at least partially within the ferrule retaining portion 212.

In embodiments, the fiber optic connector 200 is coupled to a fiber optic cable 10 at the rear portion 213 of the fiber optic connector 200 (see FIG. 3). The fiber optic cable 10 generally includes an optical fiber 12 extending through the fiber optic cable 10. The optical fiber 12 may generally extend through the connector housing 210 and the ferrule 202 along a longitudinal axis 214 of the connector housing 210. For fiber optic cables 10 including a single optical fiber 12, the optical fiber 12 may be coaxial with the longitudinal axis 214. For multifiber cables, this alignment will be orthogonally offset for one, more than one, or all of the optical fibers of the cable.

In embodiments, the connector housing 210 generally includes an outer surface 218 that extends around a perimeter of the connector housing 210, and the outer surface 218 may include one or more cross-sectional shapes. For example, in the embodiment depicted in FIG. 2, the front portion 211 of the connector housing 210 includes a rectangular cross-section including planar sides, while the rear portion 213 of the connector housing 210 includes a curved outer surface 218.

Referring briefly to FIG. 12, the shuttle 120 of a lock assembly 103 comprises a slot 124 that receives the latch 130. A wall 123 is adjacent the slot 124 to provide a hard stop for the latch 130 to prevent the latch from pivoting too far in a direction toward the first end of the housing 110.

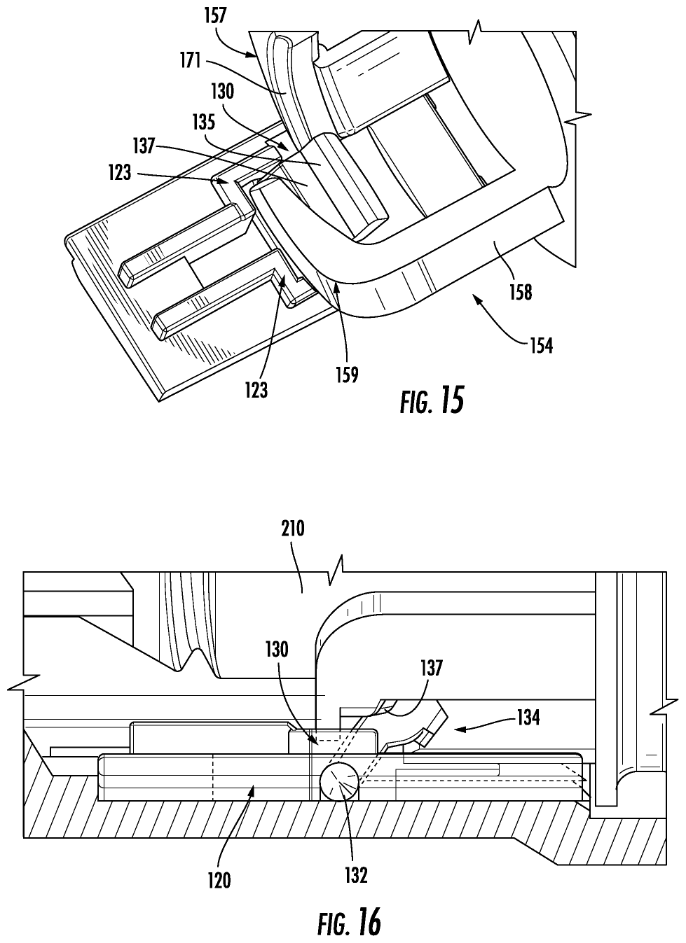

Referring once again to FIGS. 1 and 7, the latch 130 has a pivot end 132, a latching end 134, and an angled transition portion 135 between the pivot end 132 and the latching end 134. The pivot end 132 of the latch 130 snaps into the slot 124 of the shuttle 120 so that it can pivot about an axis that is perpendicular to the longitudinal axis LA of the extender port 100. As described in more detail below, a face of the latching end 134 contacts a locking face 232 of a connector housing 210 of the fiber optic connector 200 (see FIG. 14) to prevent the fiber optic connector 200 from being pulled out of the extender port 100 along the longitudinal axis LA.

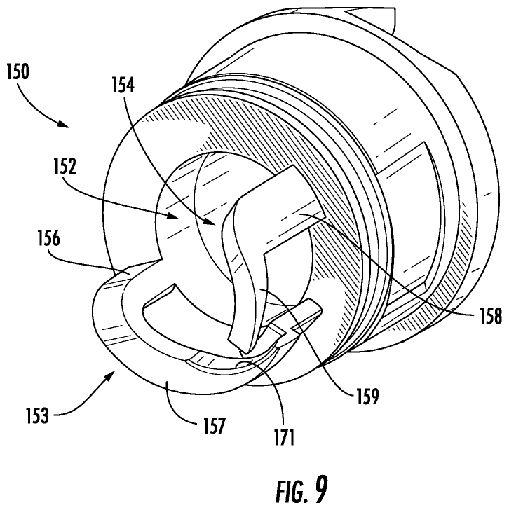

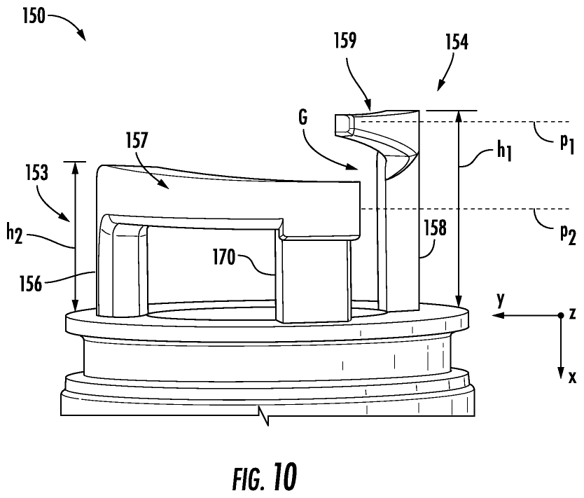

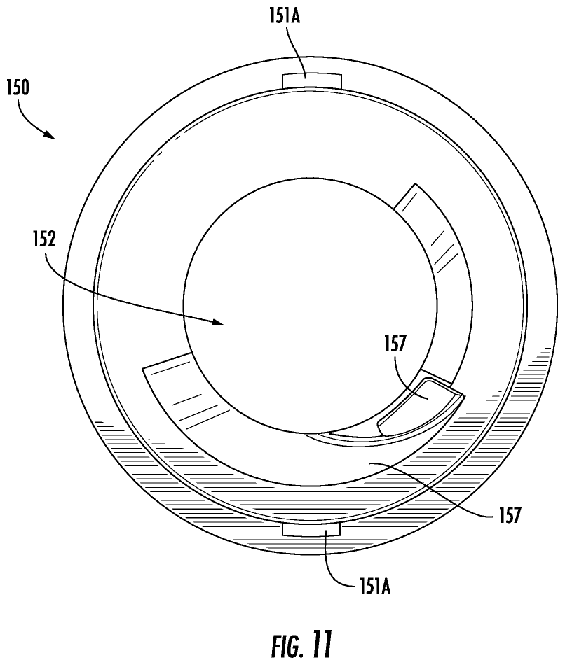

FIGS. 8 and 9 illustrate different perspective views of the example end cap 150 of FIG. 1. FIGS. 10 and 11 illustrate a side view and a front view of the example end cap 150, respectively. Referring collectively to FIGS. 8-11, the end cap 150 comprises a body 155 defining an end cap passageway 152. The end cap passageway 152 is sized to accept the fiber optic connector 200. The end cap 150 further comprises a release arm 154 and a lock arm 153 that extend from a front end of the body 155. As described in more detail below, the lock arm 153 pivots the latch 130 to a locked position such that the latching end 134 of the latch 130 is disposed between the locking face 232 of the connector housing 210 to lock the fiber optic connector 200 to the extender port 100 when the end cap 150 is rotated in a first direction with respect to the housing 110. The release arm 253 pivots the latch 130 to a released position such that the latching end 134 of the latch 130 is removed from the locking face 232 of the connector housing 210 to release the fiber optic connector 200 from the extender port 100 when the end cap 150 is rotated in a second direction with respect to the housing 110.

The lock arm 153 comprises a lock base 156 and a lock portion 157. The lock base 156 extends from a front face 173 of the body 151. As a non-limiting example, the lock base 156 extends from the front face 173 in a direction that is parallel to the longitudinal axis LA of the extender port 100 defined by the end cap passageway 152. The lock base 156 extends to a first height h₁ from the front face 173 of the base (FIG. 10). The lock portion 157 extends from the lock base 156 in a first arcuate path AP₁ within a first plane P₁. Referring particularly to FIG. 10, the first plane P₁ is defined by line drawn through a midpoint of the thickness ti at a distal end 177 of the lock portion 157. The first plane P₁ is transverse to the longitudinal axis LA. In the illustrated embodiment the first plane P₁ is orthogonal to the longitudinal axis LA. Thus, the lock arm 153 extends from the front face 173 of the body 151 and then curves around the opening defined by the end cap passageway 152 in a first arcuate path AP₁.

In the illustrated embodiment, the lock arm 153 further comprises a support portion 170 that also extends from the front face 173 of the body 151 to a second height h₂. The second height h₂ is less than the first height h₁ such that a top surface of the lock portion 157 slopes downward toward the front face of the body 151. The support portion 170 extends between the front face 173 and the distal end 177 of the of the lock portion 157. The support portion 170 provides additional rigidity to the lock portion 157 to support the lock portion 157 when a user attempts to pull out the fiber optic connector 200 when it is locked to the extender port 100. In other embodiments, the lock base 156 extends from the front face 173 along an entire length of the lock portion 157 to provide further rigidity. However, in other embodiments, only the lock base 156 shown in FIGS. 8-11 is provided without an additional support portion 170. In such embodiments, the lock portion 157 is free to flex in a direction parallel to the longitudinal axis LA and therefore the lock arm 153 does not contribute to tolerance stack-up with respect to the end position of the fiber optic connector 200 within the extender port 100.

The release arm 154 comprises a release base 158 and a release portion 159. The release base 158 extends from a front face 173 of the body 151. As a non-limiting example, the release base 158 extends from the front face 173 in a direction that is parallel to the longitudinal axis LA of the extender port 100 defined by the end cap passageway 152. The release base 158 extends to a third height h₃ from the front face 173 of the base (FIG. 10). The release portion 159 extends from the release base 158 in a second arcuate path AP₂ within a second plane P2. Referring particularly to FIG. 10, the second plane P2 is defined by line drawn through a midpoint of the thickness t₂ at a distal end 178 of the release portion 159. The second plane P₂ is transverse to the longitudinal axis LA. In the illustrated embodiment the second plane P₂ is orthogonal to the longitudinal axis LA and parallel to the first plane P₁. Thus, the release arm 154 extends from the front face 173 of the body 151 and then curves around the opening defined by the end cap passageway 152 in a second arcuate path AP₂ that has a direction that is opposite from the first arcuate path AP₁.

The first height h₁ of the lock base 156 is less than the third height h₃ of the release base 158 such that there is a gap G between the lock portion 157 and the release portion 159. The gap G should be large enough for the latching end 134 of the latch 130 to be positioned between the lock portion 157 and the release portion 159.

Referring once again to FIGS. 1 and 2, the end caps 150 are disposed within the passageway 118 at the first and seconds end 111A, 111B of the housing 110. The first and second protrusions 151A, 151B of the end caps 150 are disposed within the first and second slots 115A, 115B of the housing 110 to secure the end caps 150 to the housing 110 such that the end caps 150 may be rotated within the passageway 118 by the user turning end cap 150, such as by using a first user activation tab 160A and/or a second user activation tab 160B at a rear of the end caps 150. The first and second user activation tabs 160A, 160B provide a location for a user to grasp and turn the end cap 150 between locked and unlocked states.

In some embodiments, the end caps 150 include a circumferential groove 175 in which a sealing element 140, such as an O-ring, is disposed. The sealing element 140 is disposed between an inner surface of the housing 110 and the circumferential groove 175 of the end cap 150 to provide environmental sealing within the passageway 118.

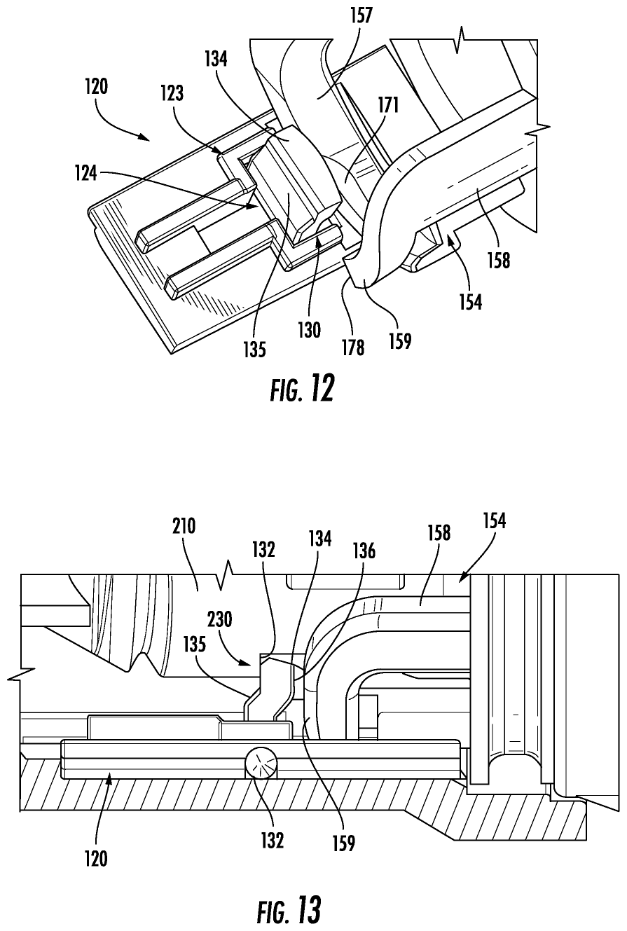

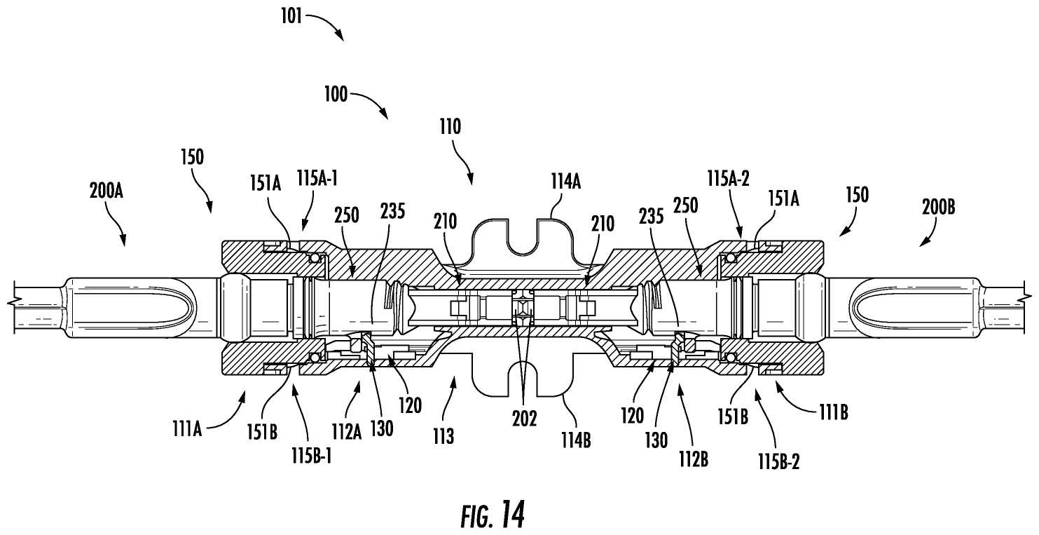

FIG. 12 illustrates a perspective view of the shuttle 120, the latch 130 and the end cap 150 when the end cap 150 is rotated to the locked position with respect to the housing 110. FIG. 13 illustrates a close-up side view of the extender port 100 and the fiber optic connector 200 when the end cap 150 is rotated to the locked position. FIG. 14 is a cross-sectional view of the first fiber optic connector 200A and the second fiber optic connector 200B inserted and locked to the extender port 100.

As shown in FIG. 12, the connector housing 210 includes a locking face 232 that extends inward from the outer surface 218 of the connector housing 210 by a distance. The locking face 232 generally defines a planar surface that is oriented transverse to the longitudinal axis of the connector. The locking face 232 is operable to contact the latching end 134 of the latch 130 when the end cap 150 is rotated to the locked position.

Referring collectively to FIGS. 7, 12, 13 and 14, when an end cap 150 is rotated to the locked position, the lock portion 157 of the lock arm 153 makes contact with the latching end 134 of the latch 130. Because the width or thickness of the lock portion 157 increases in a direction from the distal end 177 (FIG. 10) to the lock base 156, the lock portion 157 continues to pivot the latch 130 until the latching end 134 of the latch 130 is disposed between the locking face 232 of the connector and the lock portion 157 of the lock arm 153. This arrangement of the latch 130 with respect to the locking face 232 and the lock portion 157 of the lock arm 153 prevents a user from pulling the fiber optic connector 200 out of the extender port 100. Referring particularly to FIG. 12, in the illustrated embodiment the lock portion 157 has a chamfered surface 171 to ease the contact with the latching end 134 of the latch.

To unlock the fiber optic connector 200 from the extender port 100, the user rotates the end cap 150 to the unlocked position. Referring to FIGS. 7 and 12, when the user rotates the end cap 150 to the unlocked position, the distal end 178 of the release portion 159 of the release arm 154 is rotated toward the latch 130 while the distal end 177 of the lock portion 157 of the lock arm 153 is also rotated away from the latch 130.

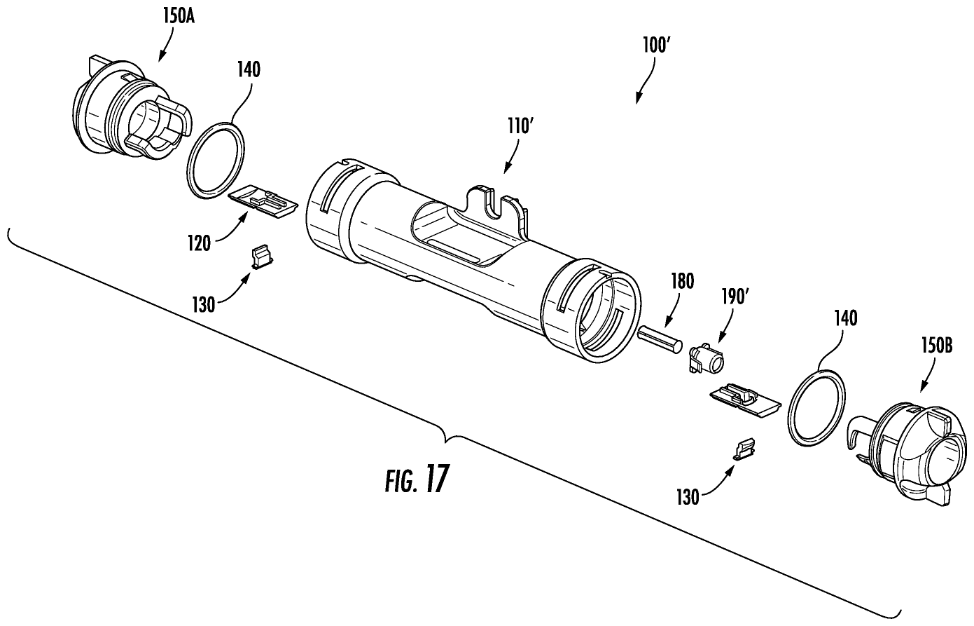

FIG. 15 illustrates an end cap 150 rotated into the unlocked position such that an inner surface of the release portion 159 contacts the transition portion 135 of the latch 130 and therefore pivots the latch in a direction toward the second end of the housing 110 that receives the end cap 150. Because the thickness of the release portion 159 increases from the distal end 178 to the release base 158, the release portion 159 gradually pivots the latch 130 to the unlocked or released position. FIG. 16 illustrates the end cap 150 in the unlocked position, and how the latch 130 is pivoted such that the latching end 134 is no longer positioned between the locking face 232 of the connector housing 210 and the lock portion 157 of the lock arm 153, and the fiber optic connector 200 can be pulled out of the extender port 100.

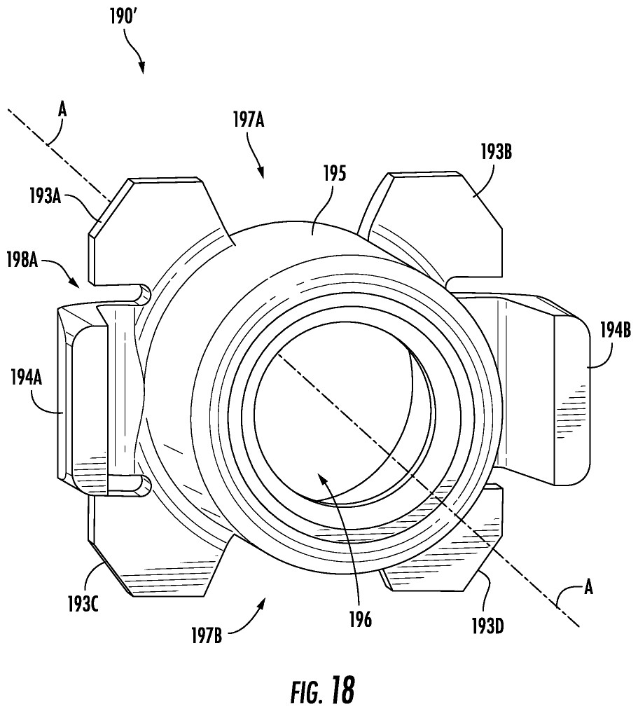

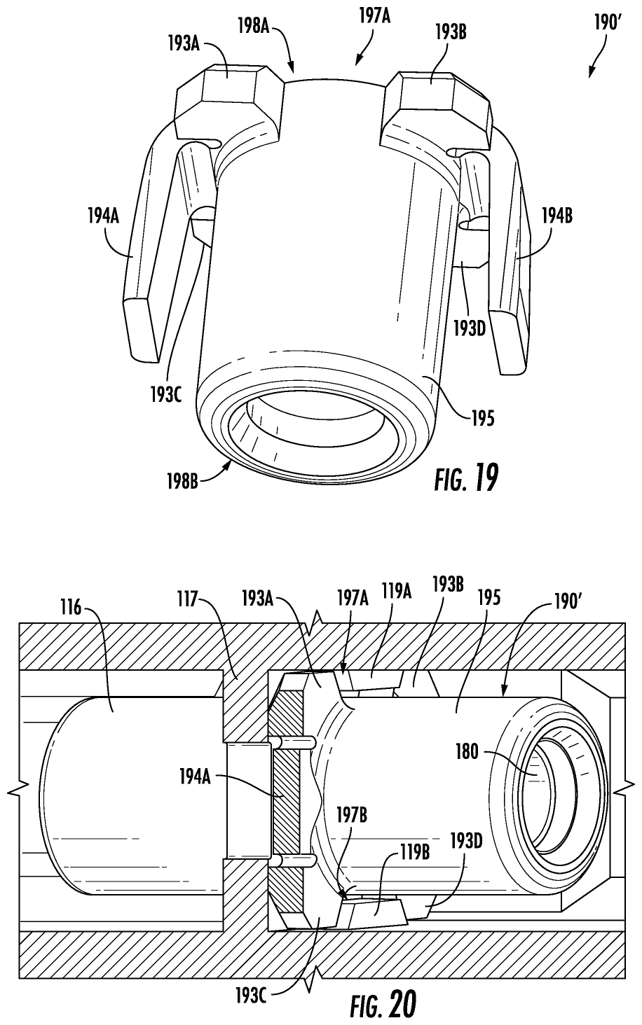

Referring now to FIG. 17, another example extender port 100′ is illustrated in an exploded view. This example extender port 100′ is similar to the extender port 100 shown in FIG. 1 except it has a different sleeve holder insert 190′. FIGS. 18 and 19 illustrate different perspective views of the sleeve holder insert 190′, which is configured to receive a ferrule sleeve 180. The sleeve holder insert 190′ has a cylindrical main body 195 that defines an opening 196 for receiving the ferrule sleeve 180. The sleeve holder insert 190′ have a first flexible extension 194A and a second flexible extension 195B protrude from a first end 198A of the main body 195 and bend toward a second end 198B of the main body 195.

In this example, the sleeve holder insert 190′ further includes alignment tabs 193A-193B that extend from the first end 198A of the main body 195 in a plane that is orthogonal to the longitudinal axis LA. Alignment tabs 193A and 193B define a first notch 197A, and alignment tabs 193C and 193D define a second notch 197B. First and second notches 197A, 197B are on sides of the first end 198A that are opposite from the sides having the first and second flexible arms 194A, 194B.

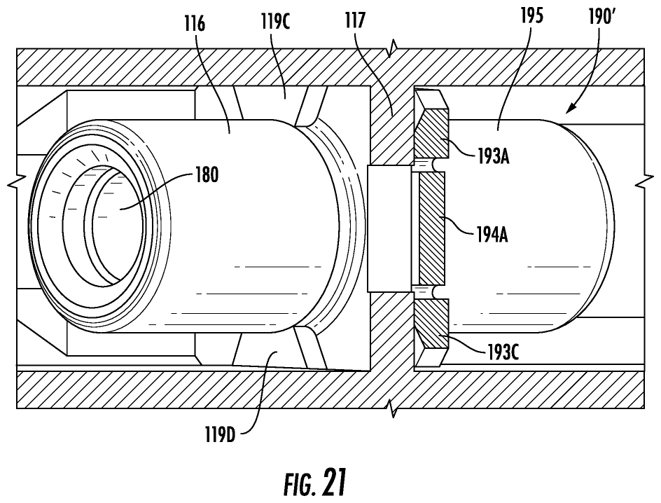

FIGS. 20 and 21 are close-up cutaway views of the sleeve holder insert 190′ positioned within the housing 110 and its interaction with the integrated sleeve holder 116. In this example, a dividing wall 117 separates two passageways for the first fiber optic connector and the second fiber optic connector. The integrated sleeve holder 116 protrudes from a first surface of the dividing wall 117 toward the first end 111A of the housing 110. A first hard stop 119A and a second hard stop 119B extend from a second surface of the dividing wall at positions such that they are disposed within the first notch 197A and the second notch 197B, respectively. The first hard stop 119A and the second hard stop 119B are thicker than the alignment tabs 193A-193D such that they protrude beyond the alignment tabs 193A-193D in a direction toward the second end 198B of the sleeve holder insert 190′.

In some embodiments, a third hard stop 119C and a fourth hard stop 119D protrude from the first surface of the dividing wall 117 in a direction toward the end of the integrated sleeve holder 116.

The hard stops 119A-119D, which may be molded into the solid housing 110, act as reference fiducials for the inserted first and second fiber optic connectors 200A, 200B. Thus, the hard stops 119A-119D eliminate assembly tolerance and reduces feature various due to their compact size.

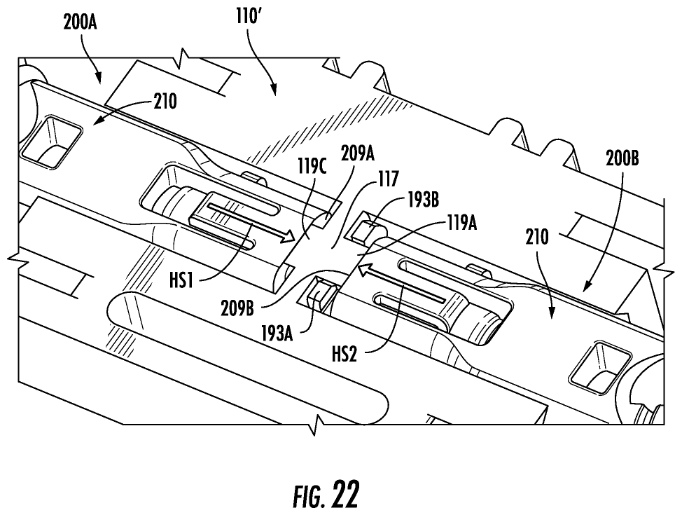

Referring now to FIG. 22, a close-up cutaway view of a first fiber optic connector 200A and a second fiber optic connector 200B inserted into a housing 110 is illustrated. Arrows HS1 and HS2 indicate the location of contact between the hard stops 119A-119D with connector housings 210 of the first fiber optic connector 200A and the second fiber optic connector 200B. Particularly, the front face 209A of the first fiber optic connector 200A contact a surface of the third hard stop 119C and the fourth hard stop 119D (not visible in FIG. 22), and the front face 209B of the second fiber optic connector 200B contact a surface of the first hard stop 119A and the second hard stop (not visible in FIG. 22). Because the connector housing 210 of the second fiber optic connector 200B does not contact the sleeve holder insert 190, tolerance stack-up is reduced, which allows for a more precise location for at least the second fiber optic connector 200B. Further, because of the small size of the hard stops 119A-119D, the first fiber optic connector 200A is also precisely located because there is less dimensional various across the surface of the third hard stop 119C and the fourth hard stop 119D than there would be along an entire surface of the dividing wall 117.

It should now be understood that embodiments of the present disclosure provide extender ports that enable optical drop cables to be quickly and cost-efficiently extended. The extender ports used herein may be advantageous in providing FTTP networks in locations where subscribers are sparsely distributed, such as rural areas. The extender ports described herein include a housing and an end cap that is rotationally coupled to the housing. The end cap includes locking and unlocking features that actuate a latch within the housing to lock and unlock an inserted fiber optic connector from the extender port. The extender port is simple and uses fewer parts than existing designs, while also providing strong tensile force resistance.

The extender port uses rotating end caps to lock and unlock fiber optic connectors to a housing. More particularly, the rotating end caps eliminate the need for external unlocking features, such as a push-button, which therefore eliminates a potential leak path and failure mode and reduces performance risk. Further, the design decouples the retention force from the user actuation force, so adjusting the retention force does not affect the user experience in any way. For example, increasing the retention force does not require a larger or different user input to release or lock the connector. The user experiences the same actuation force when turning the end cap and then pulling the fiber optic connector out of the extender port.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. An extender port for optically coupling a first fiber optic connector and a second fiber optic connector, the extender port comprising:
a housing having a first end, a second end, a first passageway for receiving the first fiber optic connector, and a second passageway for receiving the second fiber optic connector;
a first lock assembly and a second lock assembly, wherein each of the first lock assembly and the second lock assembly comprises:
a shuttle disposed on an inner surface of the housing within one of the first passageway and the second passageway, the shuttle comprising a slot;
a latch comprising a pivot end and a latching end, wherein the latch is coupled to the shuttle such that the pivot end is disposed within the slot of the shuttle; and
an end cap rotationally disposed within one of the first passageway and the second passageway, the end cap comprising a body, an end cap passageway within the body, a release arm, and a lock arm, wherein the release arm and the lock arm extend from the body such that the release arm pivots the latch to a released position when the end cap is rotated in a first direction with respect to the housing, and the lock arm pivots the latch to a locked position when the end cap is rotated in a second direction with respect to the housing.

2. The extender port of claim 1, wherein:
the housing comprises at least one first slot at the first end and at least one second slot at the second end;
the end cap comprises at least one latch protrusion extending from an exterior surface of the end cap;
the at least one latch protrusion of the first lock assembly is disposed within the at least one first slot; and
the at least one latch protrusion of the second lock assembly is disposed within the at least one second slot.

3. The extender port of claim 1, wherein the shuttle further comprises at least one hard stop adjacent to the slot.

4. The extender port of claim 1, wherein:
the lock arm comprises a lock base and a lock portion extending from the lock base;
the lock base extends from the body along a longitudinal axis of the end cap passageway;
the lock portion extends from the lock base in a first arcuate path within a first plane that is transverse to the longitudinal axis of the end cap passageway;
the release arm comprises a release base and a release portion extending from the release base;
the release base extends from the body along the longitudinal axis of the end cap passageway; and
the release portion extends from the release base in a second arcuate path within a second plane that is transverse to the longitudinal axis of the end cap passageway.

5. The extender port of claim 4, wherein a height of the lock base is different from a height of the release base such that a gap G is present between the lock base and the release base.

6. The extender port of claim 4, wherein:
a width of the lock portion becomes smaller in a direction toward a distal end of the lock portion; and
a width of the release portion becomes smaller in a direction toward a distal end of the release portion.

7. The extender port of claim 4, wherein an edge of the lock portion contacts a first surface of the latching end to pivot the latch into the locked position when the end cap is rotated into the locked position.

8. The extender port of claim 7, wherein the edge is chamfered.

9. The extender port of claim 4, wherein an edge of the release portion contacts a second surface of the latching end to pivot the latch into a release position when the end cap is rotated into the released position.

10. The extender port of claim 9, wherein the edge is chamfered.

11. The extender port of claim 1, wherein the second end of the end cap further comprises at least one user activation tab.

12. The extender port of claim 1, wherein the housing further comprises:
an integrated sleeve holder positioned between the first passageway and the second passageway;
a sleeve holder insert disposed within the second passageway and adjacent to the integrated sleeve holder; and
a sleeve disposed within the integrated sleeve holder and the sleeve holder insert.

13. The extender port of claim 12, wherein:
the sleeve holder insert comprises a main body, a first flexible extension, and a second flexible extension;
the first flexible extension and the second flexible extension protrude from a first end of the main body and bend toward a second end of the main body;
an interior surface of the second passageway of the housing comprises a groove; and
the first flexible extension and the second flexible extension are disposed within the groove to secure the sleeve holder insert within the housing.

14. The extender port of claim 13, wherein:
the housing further comprises dividing wall separating the first passageway and the second passageway;
the integrated sleeve holder protrudes from a first surface of the dividing wall in a direction toward the first end;
a first hard stop and a second hard stop positioned at a second surface of the dividing wall;
the sleeve holder insert further comprises a plurality of alignment tabs protruding from the first end of the main body;
the plurality of alignment tabs define a first notch and a second notch; and
the first hard stop is positioned within the first notch and the second hard stop is positioned within the second notch.

15. The extender port of claim 14, wherein the housing further comprises a third hard stop and a fourth hard stop protruding from the first surface of the dividing wall.

16. The extender port of claim 1, wherein the first lock assembly and the second lock assembly each comprises an O-ring in a circumferential groove of the end cap.

17. An optical assembly comprising:
a first fiber optic cable assembly comprising a first optical fiber and a first fiber optic connector, wherein the first optical fiber is disposed within the first fiber optic connector;
a second fiber optic cable assembly comprising a second optical fiber and a second fiber optic connector, wherein the second optical fiber is disposed within the second fiber optic connector;
an extender port comprising:
a housing having a first end, a second end, a first passageway for receiving the first fiber optic connector, and a second passageway for receiving the second fiber optic connector;
a first lock assembly and a second lock assembly, wherein each of the first lock assembly and the second lock assembly comprises:
a shuttle disposed on an inner surface of the housing within one of the first passageway and the second passageway, the shuttle comprising a slot;
a latch comprising a pivot end and a latching end, wherein the latch is coupled to the shuttle such that the pivot end is disposed within the slot of the shuttle; and
an end cap rotationally disposed within one of the first passageway and the second passageway, the end cap comprising a body, an end cap passageway within the body, a release arm, and a lock arm, wherein:
each of the first fiber optic connector and the second fiber optic connector comprises a connector housing;
the connector housing comprises a locking face;
the release arm and the lock arm extend from the body;
the lock arm pivots the latch to a locked position such that the latching end of the latch is disposed between the locking face of the connector housing to lock one of the first fiber optic connector and the second fiber optic connector to the housing when the end cap is rotated in a first direction with respect to the housing; and
the release arm pivots the latch to a released position such that the latching end of the latch is removed from the locking face of the connector housing to release one of the first fiber optic connector and the second fiber optic connector from the housing when the end cap is rotated in a second direction with respect to the housing.

18. The optical assembly of claim 17, wherein:
the housing comprises at least one first slot at the first end and at least one second slot at the second end; and
the end cap comprises at least one latch protrusion extending from an exterior surface of the end cap;
the at least one latch protrusion of the first lock assembly is disposed within the at least one first slot; and
the at least one latch protrusion of the second lock assembly is disposed within the at least one second slot.

19. The optical assembly of claim 17, wherein the shuttle further comprises at least one hard stop adjacent to the slot.

20. The optical assembly of claim 17, wherein:
the lock arm comprises a lock base and a lock portion extending from the lock base;
the lock base extends from the body along a longitudinal axis of the end cap passageway;
the lock portion extends from the lock base in a first arcuate path within a first plane that is transverse to the longitudinal axis of the end cap passageway;
the release arm comprises a release base and a release portion extending from the release base;
the release base extends from the body along the longitudinal axis of the end cap passageway; and
the release portion extends from the release base in a second arcuate path within a second plane that is transverse to the longitudinal axis of the end cap passageway.

21. The optical assembly of claim 20, wherein a height of the lock base is different from a height of the release base such that a gap G is present between the lock base and the release base.

22. The optical assembly of claim 20, wherein:
a width of the lock portion becomes smaller in a direction toward a distal end of the lock portion; and
a width of the release portion becomes smaller in a direction toward a distal end of the release portion.

23. The optical assembly of claim 20, wherein an edge of the lock portion contacts a first surface of the latching end to pivot the latch into the locked position when the end cap is rotated into the locked position.

24. The optical assembly of claim 23, wherein the edge is chamfered.

25. The optical assembly of claim 20, wherein an edge of the release portion contacts a second surface of the latching end to pivot the latch into a release position when the end cap is rotated into the released position.

26. The optical assembly of claim 25, wherein the edge is chamfered.

27. The optical assembly of claim 17, wherein the second end of the end cap further comprises at least one user activation tab.

28. The optical assembly of claim 17, wherein the housing further comprises:
an integrated sleeve holder positioned between the first passageway and the second passageway;
a sleeve holder insert disposed within the second passageway and adjacent to the integrated sleeve holder; and
a sleeve disposed within the integrated sleeve holder and the sleeve holder insert.

29. The optical assembly of claim 28, wherein:
the sleeve holder insert comprises a main body, a first flexible extension, and a second flexible extension;
the first flexible extension and the second flexible extension protrude from a first end of the main body and bend toward a second end of the main body;
an interior surface of the second passageway of the housing comprises a groove; and
the first flexible extension and the second flexible extension are disposed within the groove to secure the sleeve holder insert within the housing.

30. The optical assembly of claim 29, wherein:
the housing further comprises dividing wall separating the first passageway and the second passageway;
the integrated sleeve holder protrudes from a first surface of the dividing wall in a direction toward the first end;
a first hard stop and a second hard stop positioned at a second surface of the dividing wall;
the sleeve holder insert further comprises a plurality of alignment tabs protruding from the first end of the main body;
the plurality of alignment tabs define a first notch and a second notch; and
the first hard stop is positioned within the first notch and the second hard stop is positioned within the second notch.

31. The optical assembly of claim 17, wherein the first lock assembly and the second lock assembly each comprises an O-ring in a circumferential groove of the end cap.

32. An extender port for optically coupling a first fiber optic connector and a second fiber optic connector, the extender port comprising:
a housing comprising:
a first end and a second end;
a first passageway for receiving the first fiber optic connector;
a second passageway for receiving the second fiber optic connector, wherein an interior surface of the second passageway of the housing comprises a groove;
a dividing wall separating the first passageway and the second passageway;
an integrated sleeve holder that protrudes from a first surface of the dividing wall in a direction toward the first end; and
a first hard stop and a second hard stop positioned at a second surface of the dividing wall; and
a sleeve holder insert disposed within the second passageway and adjacent to the dividing wall, the sleeve holder insert comprising:
a main body;
a first flexible extension and a second flexible extension, wherein the first flexible extension and the second flexible extension protrude from a first end of the main body, bend toward a second end of the main body, and are disposed within the groove to secure the sleeve holder insert within the housing; and
a plurality of alignment tabs protruding from the first end of the main body, wherein the plurality of alignment tabs define a first notch and a second notch, the first hard stop is positioned within the first notch, and the second hard stop is positioned within the second notch.

33. The extender port of claim 32, further comprising a sleeve disposed within the integrated sleeve holder, the sleeve holder insert and through an opening in the dividing wall.

34. The extender port of claim 32, wherein the housing further comprises a third hard stop and a fourth hard stop protruding from the first surface of the dividing wall.

35. The extender port of claim 32, wherein the first flexible extension and the second flexible extension are on opposite sides of the main body from one another.
